(19) United States
(12) Patent Application Publication
(10) Pub. No.: US 2006/0136250 A1
(43) Pub. Date: Jun. 22, 2006

(54) Method, computer program product and computer system for measuring the impact of a proposed change in an organisation

(75) Inventor: Gregory Alan Farmilo, Baulkham Hills (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Centrique Pty Limited, North Parramatta (AU)

(21) Appl. No.: 11/154,268

(22) Filed: Jun. 15, 2005

(30) Foreign Application Priority Data
Dec. 22, 2004 (AU) 2004907280

(51) Int. Cl. G06F 17/30

(52) U.S. Cl. 705/1

(57) ABSTRACT

A computer-based method, a computer program product and a computer system for measuring the impact of a proposed change in an organisation are disclosed. The method comprises the steps of inputting financial data relating to the organisation; inputting human resource data relating to the organisation; inputting data relating to one or more proposed initiatives for the organisation; and generating a business action plan for the organisation based on the financial, human resource and proposed initiatives data. The computer program product and the computer system provide means for practising the above method.

### FIELD OF THE INVENTION

The present invention relates generally to change management in an organisation and more particularly to a computer-based method, computer program product and computer system that assists in efficiently measuring the impact of a proposed change in an organisation.

### BACKGROUND

In recent years, information technology has been increasingly employed by individuals and organisations to automate and improve efficiencies in daily tasks and organisational management. In particular, the increased affordability of the personal computer and widespread availability of computer software has seen the emergence of numerous software-based planning tools that enable users to effectively write business plans and enable development of practical project management and human resource plans for their business.

Certain software-based planning tools offering single (or point) solutions are available in the market that address specific issues in business planning. For example, software products such as Business Planning from SOHO, Masterplan from MAUS and Business Planning from Bplans.com provide users of the software with the capability to develop a plan for an organisation. The majority of such software-based planning tools rely heavily on researching and developing a plan for either a new business and/or for business finance. Thus, these software tools tend to exclude most mature businesses or organisations requiring simplified whole-of-business strategy planning solutions. Furthermore, such tools tend to rely on a consultant or the computer software itself to produce large amounts of information on the nature of the organisation; the current state of play in the market; and recommendations on the future direction of the organisation. However, a disadvantage of such arrangements is that they do not provide an effective means for analysing the viability of a business change based on the financial and human resource constraints and other potential growth activities of that business.

Business Planning software tools are designed primarily to build a complete business and market profile for new businesses or for financing purposes, necessitating thorough researching over long periods of time, usually counted in months. A disadvantage of such tools is that they fail to deliver an effective assessment of the impacts of change in a relatively short timeframe.

A number of project management software tools are available on the market. For example, Project Planner from MAUS and Project Professional 2003 from Microsoft are two such tools enabling an individual or organisation to manage projects. However, a disadvantage of such arrangements is that they are typically task oriented and restrict the user to managing a project in isolation from the organisation and therefore provide no holistic overview of the organisation and no dynamic link between the constraints and potential growth activities of the organisation.

A number of Human Resource (HR) management software tools are also available on the market. For example, Managepro.com provides an HR management software tool that enables an individual or organisation to plan for future staffing requirements of an organisation including staff availability and productivity. However, a disadvantage of such tools is that they fail to provide a holistic or overall analysis of an organisation. Generally, such tools tend to focus exclusively on only one, albeit important, resource constraint of the business.

The foregoing constitutes a discussion of specific existing arrangements and should not be taken as an admission of common general knowledge in the relevant field.

In summary, a general disadvantage of existing arrangements is that such arrangements assist users with a single function (or point solution) in isolation and fail to provide a single, comprehensive solution capable of efficiently integrating financial, project planning and HRP information and providing a user with a holistic and customised business action plan for the entire organisation that measures the impact of each planned change.

Therefore, a need exists to provide a software-based planning tool that overcomes or substantially ameliorates one or more disadvantages and shortcomings of existing arrangements.

### SUMMARY

Aspects of the present invention provide a computer-based method, computer program product, and computer system for measuring the impact of a proposed change in an organisation.

In an aspect of the invention, there is provided a computer-based method for measuring the impact of a proposed change in an organisation. The method comprises the steps of inputting financial data relating to the organisation; inputting human resource data relating to the organisation; inputting data relating to one or more proposed initiatives for the organisation; and generating a business action plan for the organisation based on the financial, human resource and proposed initiatives data.

In another aspect of the invention, there is provided a computer program product having a computer readable medium having a computer program recorded therein for measuring the impact of a proposed change in an organisation. The computer program product comprises computer program code for inputting financial data relating to the organisation; computer program code for inputting human resource data relating to the organisation; computer program code for inputting data relating to one or more proposed initiatives for the organisation; and computer program code for generating a business action plan for the organisation based on the financial, human resource and proposed initiatives data. The generated business action plan comprises a forecast for the organisation as a whole that incorporates the proposed initiatives data.

The computer program code for generating the business action plan may comprise computer program code for generating a financial budget for the organisation.

The computer program code for inputting data relating to the proposed initiatives may comprise computer program code for inputting costs relating to the proposed initiatives.

The computer program code for inputting human resource data may comprise computer program code for inputting data relating to cost, availability and productivity of the human resources.

The business action plan may comprise one or more sub-plans including an operations sub-plan; a financial sub-plan; a marketing sub-plan; and a human resource sub-plan.

The computer program product may further comprise computer program code for amending the data relating to the proposed initiative. The financial data and the human resource data are automatically updated in response to the amendment of the data relating to the proposed initiative. The computer program product may further comprise computer program code for generating an amended business action plan based upon the amended data relating to the proposed initiative.

In another aspect of the invention, there is provided a computer system for measuring the impact of a proposed change in an organisation comprising a memory unit for storing data and instructions to be performed by a processing unit; and a processing unit coupled to the memory unit. The processing unit is programmed to obtain financial data relating to the organisation; obtain human resource data relating to the organisation; obtain data relating to one or more proposed initiatives for the organisation; and generate a business action plan for the organisation based on the financial, human resource and proposed initiatives data. The generated business action plan comprises a forecast for the organisation as a whole that incorporates the proposed initiatives data.

### BRIEF DESCRIPTION OF THE DRAWINGS

A small number of embodiments of the present invention will now be described, by way of example only, with reference to the accompanying drawings, in which:

FIG. 1 is a flowchart of a computer-based method for measuring the impact of a proposed change in an organisation;

FIG. 2 is a flowchart of another computer-based method for measuring the impact of a proposed change in an organisation;

FIG. 3 is a schematic block diagram showing the major modules of a computer program for measuring the impact of a proposed change in an organisation;

FIG. 4 is a schematic block diagram showing the Introduction module of the computer program of FIG. 3;

FIG. 5 is a schematic block diagram showing the Setup Plan module of the computer program of FIG. 3;

FIG. 6 is a schematic block diagram showing the Projects sub-module of the computer program of FIG. 3;

FIG. 7 is a software screen capture of the Projects Details screen;

FIG. 8 is a schematic block diagram showing the Reports module of the computer program of FIG. 3;

FIG. 9 is a software screen capture of the Budget with Projects screen;

FIG. 10 is a software screen capture of the Forecast Profit and Loss screen;

FIG. 11 is a software screen capture of the Budget with Profit screen;

FIG. 12 is a software screen capture of the Human Resource Cost screen;

FIG. 13 is a schematic block diagram showing the Master Plan module of the computer program of FIG. 3;

FIG. 14 is a schematic block diagram showing the Plan Overview sub-module of the Master Plan module of the computer program of FIG. 3;

FIG. 15 is a schematic block diagram showing the System module of the computer program of FIG. 3;

FIG. 16 is a flowchart showing the typical steps taken by a user in using the computer program of FIG. 3, for measuring the impact of a proposed change in an organisation;

FIG. 17 is a schematic block diagram of a general purpose computer system with which embodiments of the present invention may be practiced.

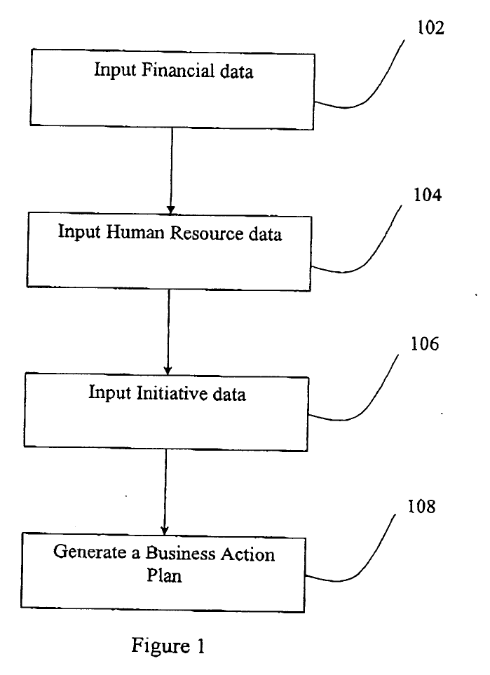

Where reference is made in any one or more of FIGS. 1 to 17 of the accompanying drawings to steps and/or features, which have the same reference numerals, those steps and/or features have for the purposes of this specification the same function(s) or operation(s), unless stated to the contrary.

### DETAILED DESCRIPTION

FIGS. 1 to 17 relate to a computer-based method, a computer program product and a computer system for measuring the impact of a proposed change in an organisation according to embodiments of the present invention. Such proposed changes include proposed initiatives and proposed projects and these terms are used interchangeably in the present specification.

FIG. 1 is a flowchart of a computer-based method for measuring the impact of a proposed change in an organisation. At step 102, financial data pertinent to the particular organisation (such as profit and loss data) is input. At step 104, human resource data relating to the organisation is input. At step 106, initiative (or project) data relating to one or more proposed initiatives of the organisation is input. At step 108, a business plan for the organisation is generated based on the financial, human resource and proposed initiatives data input at steps 102, 104 and 106 respectively. The generated business action plan comprises a forecast for the organisation as a whole that incorporates the proposed initiatives data.

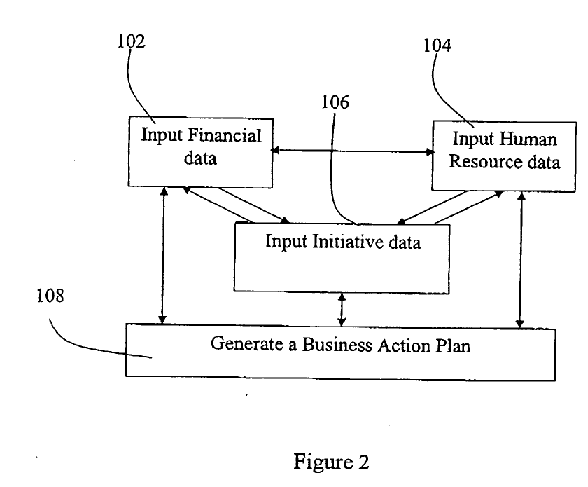

FIG. 2 is a flowchart of another computer-based method for measuring the impact of a proposed change in an organisation. Like reference designators in FIG. 1 and FIG. 2 are intended to convey the same or substantially equivalent steps. However, FIG. 2 shows that steps 102, 104, 106 and 108 may be performed iteratively. For example, a user may input financial data at step 102 and input human resource data at step 104. The user may then optionally generate a business action plan at step 108, prior to input of proposed initiative data at step 106. Thereafter, the user may input proposed initiative data at step 106 and optionally regenerate a business action plan at step 108 that incorporates the proposed initiative data. Thereafter, the user may return to any of the steps 102, 104, and 106 to amend or enter additional data before again regenerating a business action plan at step 108. In this manner, the user may iteratively and continuously review the impact of the proposed initiative(s) in the organisation.

As an example, the user may wish to measure the impact of employing an additional staff member in an organisation. The user may input financial data at step 102 and input human resource data at step 104. Thereafter, the user may input initiative data relating to the employment of the staff member at step 106. Thereafter, the user may consider the impact of employing the additional staff member and return to any of the steps 102, 104, and 106 to amend or enter additional data in relation to the employment of the staff member. Based on this continuous and iterative review, the user may consider a range of possibilities in regard to the timing and costs associated with the proposed employment of the staff member. As a result of this analysis, the user may decide whether the proposed initiative is affordable and advantageous to the organisation, or otherwise. That is, the user may decide whether to proceed with the employment of an additional staff member, or not. Optionally, the user may generate a business action plan at step 108.

The process of measuring the impact of a proposed change in an organisation (as described above) is relatively fast and efficient compared to conventional business planning. Moreover, embodiments of the present invention enable evaluation of one or more proposed initiatives in an organisation using data that is typically readily available. This advantageously avoids or at least ameliorates the need for intensive research and analysis that frequently accompanies conventional business planning.

Typically, an organisation may review the proposed initiative(s) and generate a business action plan on an ad-hoc basis or at regular intervals (e.g. on a monthly or weekly basis). The process may occur as often as is required.

In the context of the present specification, the term “business action plan” is intended to denote an overall plan for an organisation, incorporating one or more proposed “actions” or “initiatives”. The generated business action plan may comprise one or more sub-plans and other reports, including an operations sub-plan; a financial sub-plan; a marketing sub-plan; and a human resource sub-plan.

In certain embodiments, the generated business action plan may include a financial budget for the organisation incorporating the proposed initiative(s) (or project(s)). For each of the proposed initiative(s), financial and human resource cost information may be allocated. The inputted human resource data may include information relating to the costs of staff members; availability of staff members for a particular proposed initiative; and productivity of staff members of the organisation. The financial, human resource and proposed initiative data may be continuously reviewed and/or amended prior to generation of the business action plan.

The generated business action plan provides an indication of the impact that the proposed initiative(s) will have in regard to the whole organisation. This is presented in terms of the financial constraints; the human resource constraints; and the timing of the proposed initiatives.

In a formalised presentation form (applicable for presentation to banks and other third parties), the business action plan typically includes a forecast for the organisation as a whole that incorporates the proposed initiative(s) data, the forecast financial results, and the forecast human resource costs. The formalised business action plan may also include a brief organisational profile, situation analyses, goal identification and project rationale information.

In certain embodiments, the generated business action plan may be produced in a short form for use by then management of the organisation. The short form business action plan typically includes a graphical representation of the initiative(s), and the impact of the initiative(s) on the financial and human resource constraints of the organisation. The short form business action plan typically also includes a forecast for the organisation as a whole that incorporates the proposed initiative(s) data, the forecast financial results, and the forecast human resource costs.

Computer Program for Measuring the Impact of a Proposed Change in an Organisation

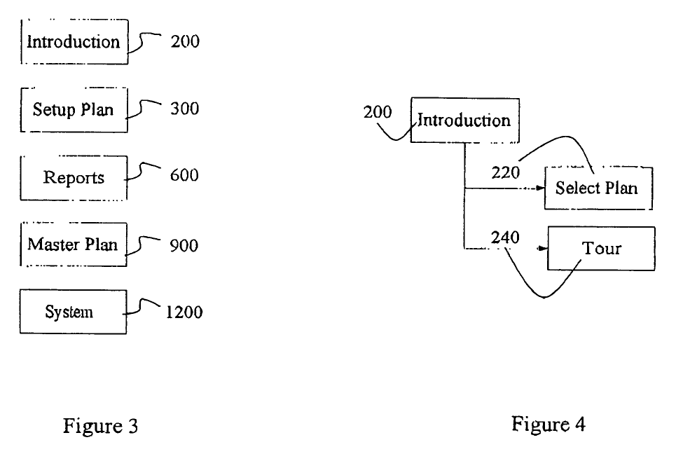

FIG. 3 shows the major modules of a computer program for performing a computer-based method of measuring the impact of a proposed change in an organisation. The computer program has five top-level modules—the Introduction module 200, the Setup Plan module 300, the Reports module 600, the Master Plan module 900 and the System module 1200.

Introduction Module

Referring to FIG. 4, the Introduction module 200 enables the computer program product to be initialised in readiness for use. The Introduction module 200 comprises two sub-modules—the Select Plan sub-module 220 and the Tour submodule 240. The Select Plan sub-module 220 displays a list of company (or organisation) names currently stored in the computer program and allows maintenance of these company names. Company names may be created, deleted or duplicated. To initialise the computer program for use, a plan (an external data file) is imported into the computer program and assigned to a company name. The company name is opened in preparation for measuring the impact of a proposed change in the organisation. Plan data may also be exported from the Select Plan sub-module 220.

The Tour sub-module 240 provides an HTML-based graphical user guide for the computer program.

Setup Plan Module

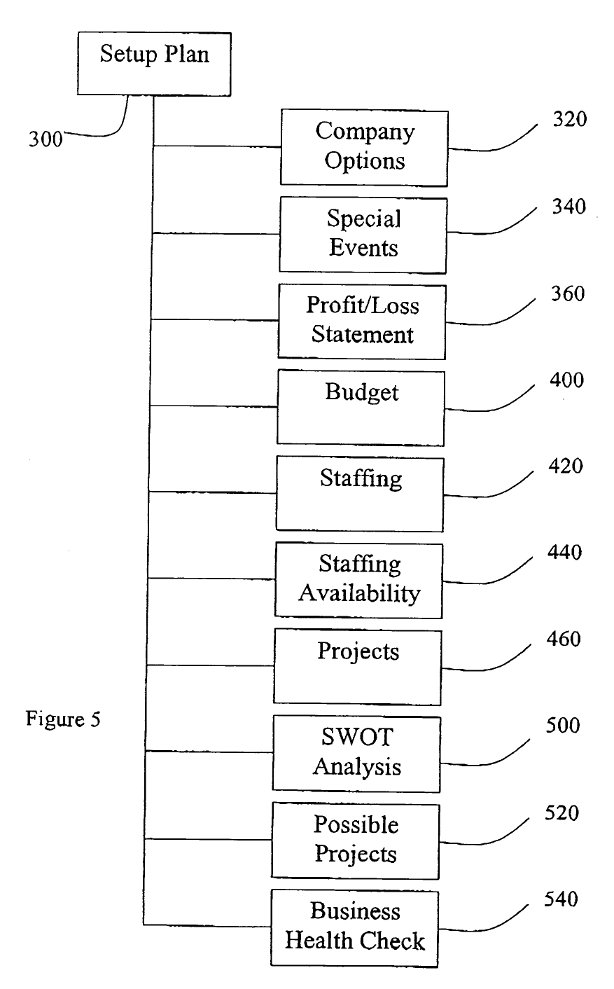

Referring to FIG. 5, the Setup Plan module 300 comprises a Company Options sub-module 320; a Special Events sub-module 340; a Profit/Loss Statement sub-module 360; a Budget sub-module 400, a Staffing sub-module 420; a Staffing Availability sub-module 440; a Projects sub-module 460; a Strengths, Weaknesses, Opportunities, Threats (SWOT) Analysis sub-module 500; a Possible Projects sub-module 520 and a Business Health Check sub-module 540.

The Company Options sub-module 320 enables basic plan information to be maintained. Information including the company name; the plan start date and the plan end date; and the number of months for the plan period may be entered. The option to run a single plan or a multiple plan (multi-plan) is provided. A multi-plan configuration enables organisations with multiple divisions to run sub-financial budgets for each of those divisions.

The Special Events sub-module 340 records special events for the organisation in the plan period. Special events may include, for example, Christmas, trade shows, or an Annual General Meeting. The Special Events sub-module 340 displays and maintains special event data including the date and description of the event and a colour coding for the event. Invocation of report functionality displays a list of Special Events for the organisation.

The Profit/Loss Statement sub-module 360 enables financial accounts data for the organisation to be entered and maintained. New accounts data may be created and existing accounts data may be amended or deleted. Account data may include an account number; an account group; a description of the account entry; an account entry balance; and whether the account entry is included in the inventory.

Financial accounts Profit and Loss Statement information may be imported, for example, from a Comma Separated Value (CSV) file; created using a pre-determined account set (Chart of Accounts); or created manually. Once the Profit and Loss Statement has been prepared, an organisational budget may be generated for the plan. The computer program generates a simple month-by-month financial budget from the input Profit and Loss Statement information. Adjustments may be made to the budget for any known seasonal or other trends likely to occur in the plan period. Amendments may be made directly to the budget for any other reason. Invocation of report functionality displays a Profit and Loss Statement for the organisation which may be used at a later time for comparative purposes.

The Budget sub-module 400 enables manual adjustment of the organisational budget generated in the Profit/Loss Statement sub-module 360. The budget may be adjusted to cater for expected changes in the organisation such as seasonal trends and varying monthly expenditure. Budgetary data may be adjusted for any month in the plan period. Invocation of report functionality displays a “pre-initiative” budget for the organisation. This budget report does not include costs associated with the proposed initiatives (or projects) of the organisation. The budget report may be displayed as a consolidated report for the entire organisation or as a budget report for each division of the organisation.

The Staffing sub-module 420 enables details of staff members to be maintained. The Staffing sub-module 420 enables addition, deletion and modification of staff information such as a staff member's name and position; the number of hours worked per week; the staff member's productivity rating; cost; and anticipated annual leave dates for the staff member during the plan period. Invocation of report functionality displays staff information for the organisation. A staffing availability budget may be generated to calculate the monthly breakdown of staff hours for all staff members. Adjustments may be made to the staffing availability budget for any known seasonal or other trends likely to occur in the plan period. Amendments may be made directly to the staffing availability budget for any other reason. Any changes to initiative (or project) data will be directly reflected in the staffing availability budget.

The Staffing Availability sub-module 440 displays monthly staff availability during the plan period and enables adjustment of this availability to cater for anticipated monthly or seasonal changes for the organisation. Invocation of report functionality displays availability and productivity scheduling for the staff members during the plan period.

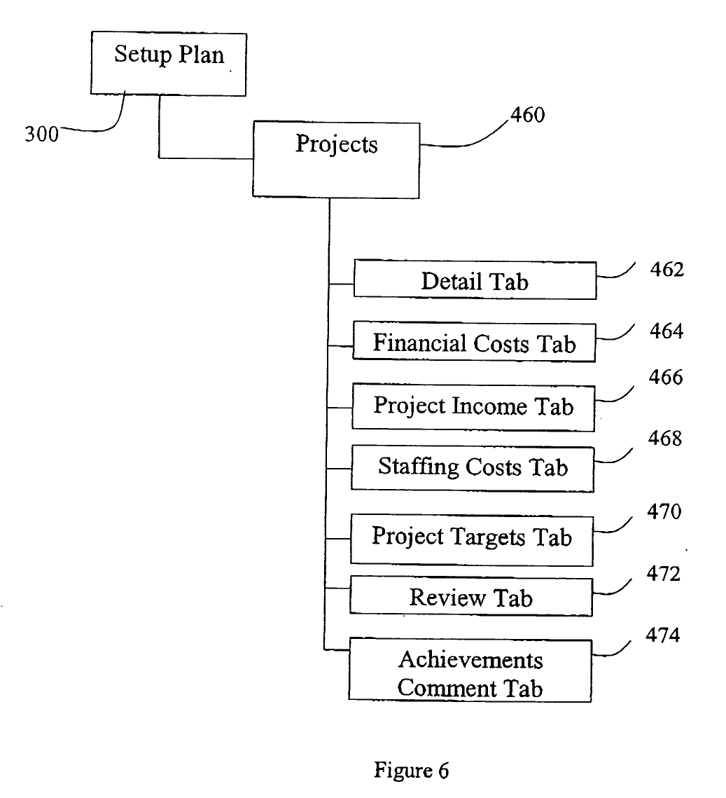

Referring to FIG. 6, the Projects sub-module 460 enables information relating to the proposed initiatives (hereinafter called projects) of the organisation to be displayed and maintained. The Projects sub-module 460 includes seven screen areas in a tabbed arrangement—the Detail tab 462; the Financial Costs tab 464; the Project Income tab 466; the Staffing Costs tab 468; the Project Targets tab 470; the Review tab 472; and the Achievements Comment tab 474.

The Detail tab 462 displays and maintains project information such as the Project ID; a short description of the project; the person responsible for the project; the project start date; and the project completion date. Projects may be created, amended and deleted.

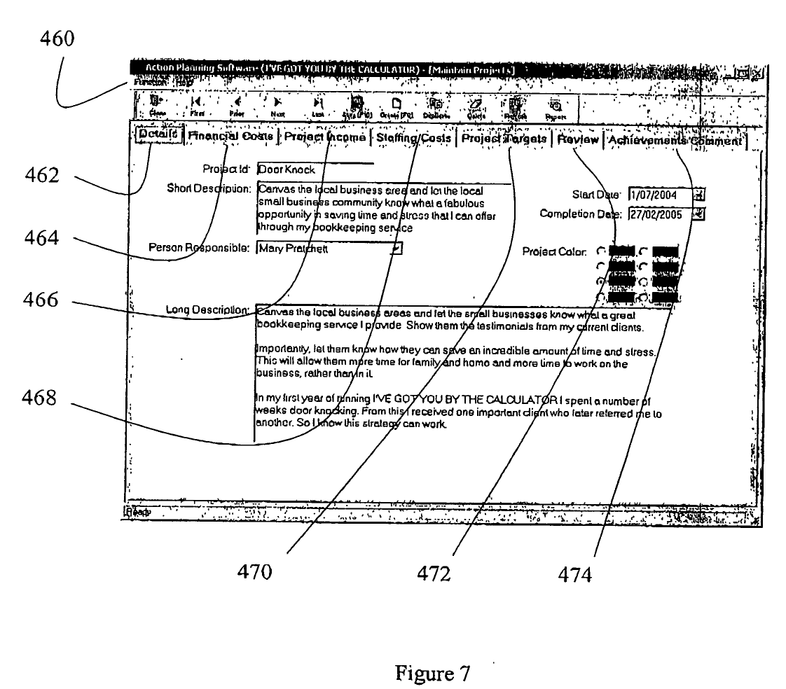

In addition, the Projects sub-module 460 may be used to maintain further details relating to each project. The Financial Costs tab 464 enables financial costs for each component of the project to be maintained. The Project Income tab 466 may be used to record any income derived from the project during the plan period. The Staffing Costs tab 468 may be used to maintain staffing costs for the project. The Project Targets tab 470 enables maintenance of project targets and timing. The Review tab 472 may be used to record project review information for ongoing progress reporting Of the project once it has commenced. The Achievements Comment tab 474 records project achievement commentary for ongoing review purposes of the project once it has commenced. Invocation of report functionality displays a list of the projects for the plan period. FIG. 7 displays a screen capture of the Projects sub-module 460.

Referring to FIG. 5, the SWOT Analysis sub-module 500, the Possible Projects sub-module 520 and the Business Health Check sub-module 540 provide brainstorming activities. The SWOT Analysis sub-module 500 enables maintenance of information regarding the organisation's strengths, weaknesses, opportunities and threats. Examples of possible strengths, weaknesses, opportunities and threats are stored in the computer program and may be selected by a user, if required. The Possible Projects sub-module 520 provides a list of example projects that are typically considered when planning for business growth. The Business Health Check sub-module 540 provides a list of questions to assist in identifying possible flaws in the organisation and the planning process.

Reports Module 600

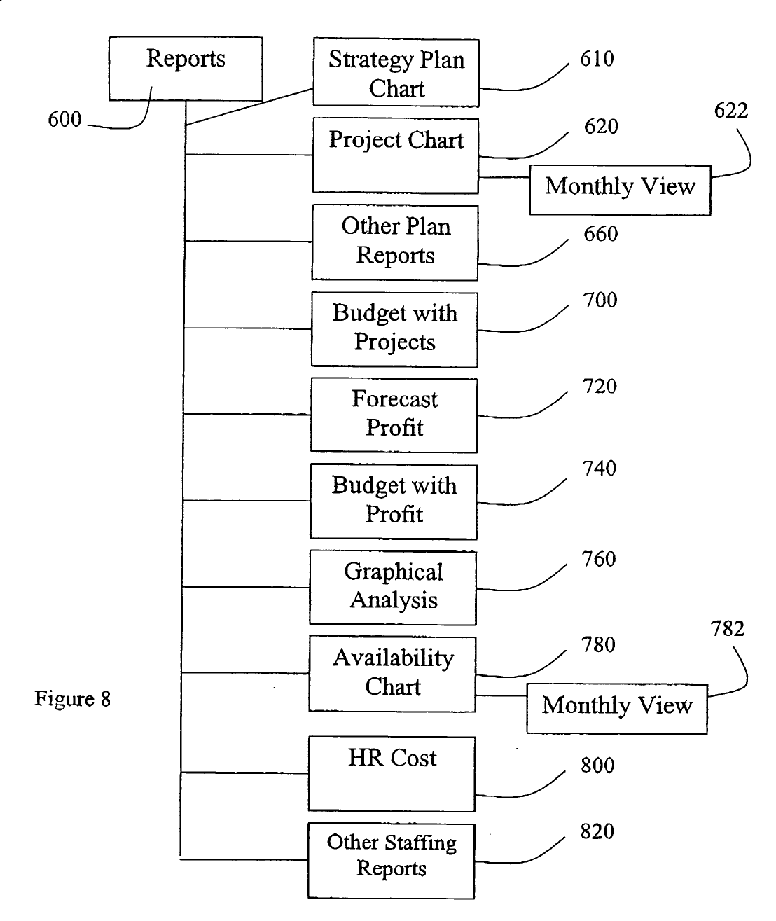

Referring to FIG. 8, the Reports module 600 provides reporting capability on the financial; human resource; and project data of the organisation. The Reports module 600 comprises a Strategy Plan Chart sub-module 610; a Project Chart sub-module 620; an Other Plan Reports sub-module 660; a Budget with Projects sub-module 700; a Forecast Profit sub-module 720; a Budget with Profit sub-module 740; a Graphical Analysis sub-module 760; an Availability Chart sub-module 780; an HR Cost sub-module 800; and an Other Staffing Reports sub-module 820.

The Strategy Project Chart sub-module 610 graphically displays a timeline of projects and special events for the organisation in the plan period. The Strategy Project Chart sub-module 610 includes a graphical display of the surplus (or deficit) labour hours for a project and a graphical display of the financial surplus (or deficit) for the project over (he same period of time A project may have a colour assigned to it for ease of identification on the timeline. Selection of an Amend function enables changes to be made to the project. Amendment of the start date of the project will reset all human resource and financial budgets. The Amend function also enables a project to be deleted. Deletion of a project will reset the human resource and financial budgets. Invocation of report functionality displays a graphical representation of the timeline for the organisation and includes the projects, special events and the surplus (or deficit) for the human resource and financial plans for the plan period.

The Project Chart sub-module 620 graphically displays a timeline of projects and special events for the Organisation in the plan period. A project may have a colour assigned to it for ease of identification on the timeline. A monthly view of the Project Chart 622 is invoked by clicking on a particular month in the plan period. The monthly view of the Project Chart 622 provides a day-by-day breakdown of the projects and special events for the plan period. The monthly view of the Project Chart 622 also highlights any forecast target setting to be achieved on those projects. Selection of an Amend function enables changes to be made to the project. The human resource and financial budgets of the project may be reset when amending a project. Invocation of report functionality displays a graphical representation of the timeline (either monthly or daily) for the organisation and includes the projects and special events for the plan period.

The Other Plan Reports sub-module 660 provides a list of additional project reports. These include a project list report; a project report; a project achievements report; a project targets report; and project review comments report.

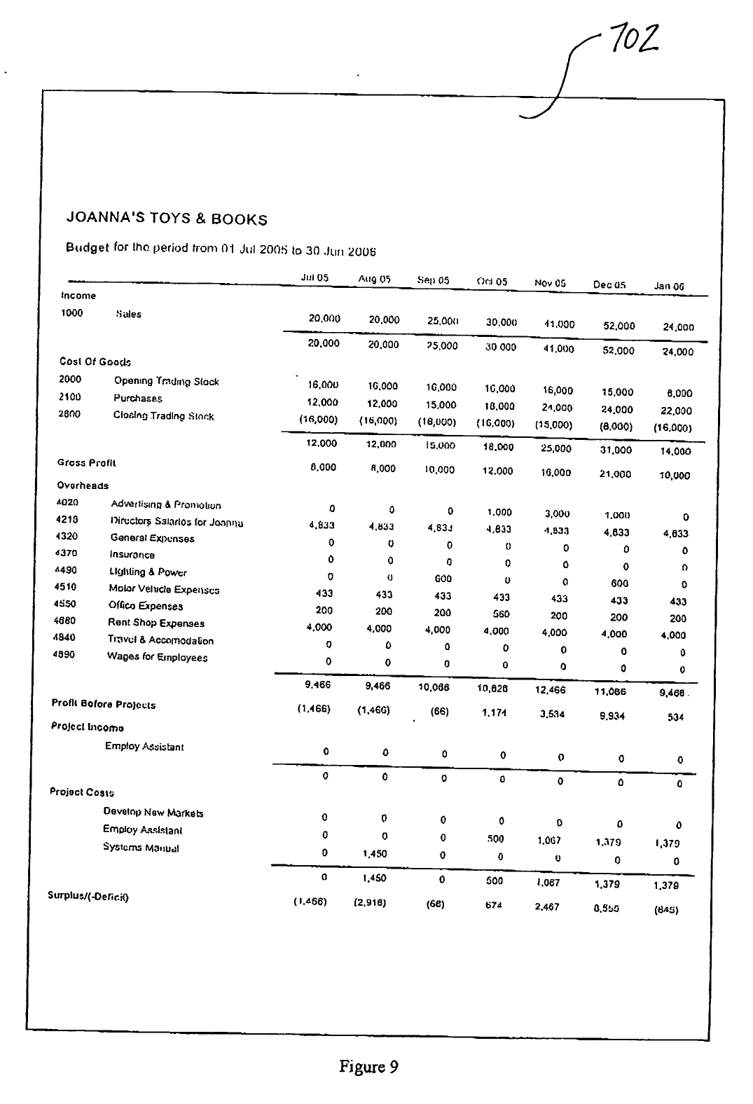

Hereinafter, FIGS. 9 to 12 show financial information in relation to the fictitious organisation “Joanna's Toys & Books”, generated in accordance, with an embodiment of the present invention.

The Budget with Projects sub-module 700 displays an overall organisational budget report 702 for the plan period. Referring to FIG. 9, the budget report 702 provides a financial budget (Income—Expenditure) for the organisation prior to inclusion of the financial cost data relating to the proposed projects. This financial budget represents the Forecast Profitability of the organisation for the plan period and does not account for the financial impacts of the proposed projects. The Forecast Profitability is then integrated with the financial cost data of the proposed projects. Accordingly, the budget report 702 accounts for the financial impacts imposed by the projects to provide a “bottom-line” financial budget for the plan period. The result is a surplus (or deficit) budget, according to the general formula:
(Income−Expenditure)+/−Projects=Surplus (or Deficit)

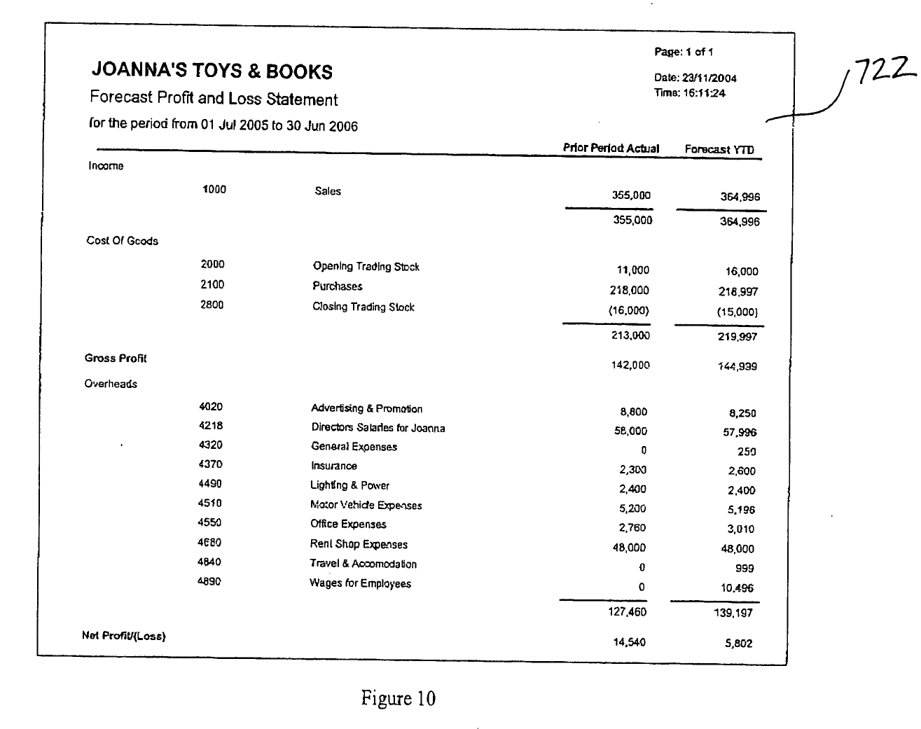

Referring to FIG. 8, the Forecast Profit sub-module 720 displays a Forecast Profit and Loss Statement 722 Referring to FIG. 10, the Forecast Profit and Loss Statement 722 compares the forecast profit and loss data for the organisation with the actual profit and loss data for the organisation for a prior plan period.

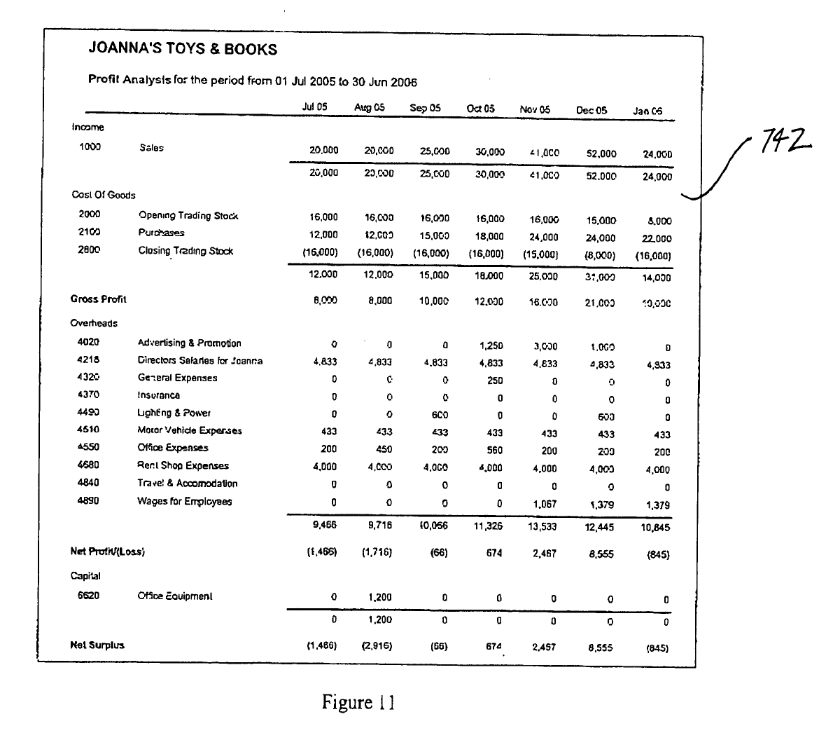

Referring to FIG. 8, the Budget with Profit sub-module 740 displays a Budget with Profit report 742. Referring to FIG. 11, the Budget with Profit Report 742 provides an accountant's interpretation of the budget for the plan period integrating the changes imposed by the projects. Rather than showing projects, the costs associated with the projects are allocated directly to the income, expenses and capital for the plan period. The result is a surplus (or deficit) according to the general formula:
Income−Expenditure+/−Capital=Surplus (or Deficit)
This surplus (or deficit) is equal to the surplus (or deficit) as described above in the budget report 702.

The Budget with Profit report 742 provides a sub-total of (Income−Expenditure), before integration of the capital. This sub-total is the Forecast Profitability of the organisation for the coming period incorporating all proposed projects financial data.

Referring to FIG. 8, the Graphical Analysis sub-module 760 displays a graphical representation of forecast cumulative sales for the organisation; forecast profitability for the organisation; and a pie chart breakdown of the costs of goods, income and overheads for the organisation.

Referring to FIG. 8, the Availability Chart sub-module 780 displays a graphical representation of staff member productivity for the organisation incorporating the projects for the plan period. Monthly resource productivity for staff members is colour-coded. Day-to-day labour arrangements may be reviewed. The colour green represents under-utilised staff members having surplus capacity, should extra work be required. Yellow represents fully utilised staff members having no surplus capacity. If extra work is required, the utilisation of staff members may be increased to accommodate the workload. Red represents over-utilised staff members with an excess of work to process within normal working hours. Generally, an over-utilisation of staff indicates that the staffing capacity is in deficit Normal working hours and productivity may be reviewed and extended. Checklist functionality may be invoked to display a responsibilities checklist for each staff member. Alternatively, the checklist may be invoked by clicking on the details for the staff member in the Availability Chart sub-module 780.

A monthly view 782 of the Availability Chart provides a day-by-day breakdown of the staff member productivity for the plan period. The monthly view 782 of the Availability Chart is invoked by clicking on a particular month in the plan period in the Availability Chart sub-module 780. Invocation of report functionality displays a graphical representation of staff member availability (monthly or daily) for the plan period.

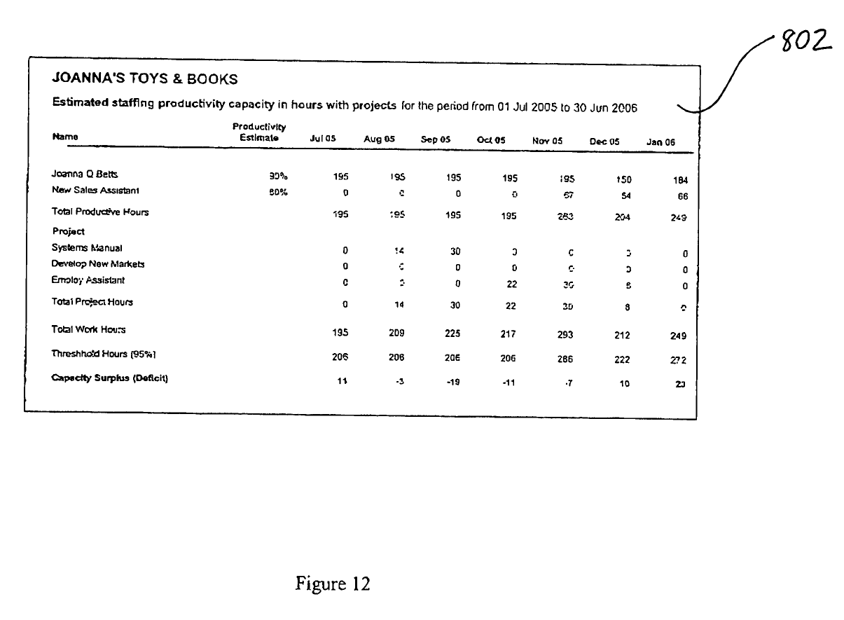

The Human Resource (HR) Cost sub-module 800 displays a productivity schedule (or capacity) report 802. Referring to FIG. 12, the productivity schedule (or capacity) report 802 includes the name of each staff member; a productivity estimate for each staff member; and the anticipated hours to be worked by each staff member for each month during the plan period. The productivity schedule (or capacity) report 802 also displays the anticipated work hours required for each proposed project of the organisation. Information is provided on the productive hours of the organisation and the total project work hours. Thus, a “work hours” capacity (either a surplus or a deficit) may be calculated for the organisation. The productivity schedule report 802 displays the staffing budget of the organisation prior to inclusion of the financial cost data relating to the proposed projects. The staffing budget is then integrated with the financial cost data of the proposed projects. Thus, the productivity schedule (or capacity) report 802 accounts for the human resource impacts imposed by the projects, according to the general formula:
Usual Staffing Budget+/−Projects=Surplus (or Deficit)

Referring to FIG. 8, the Other Staffing Reports sub-module 820 displays a list of staff reports. These reports include a responsibility checklist for the plan period, a responsibility checklist for the manager and a responsibility checklist for the staff member.

Master Plan Module

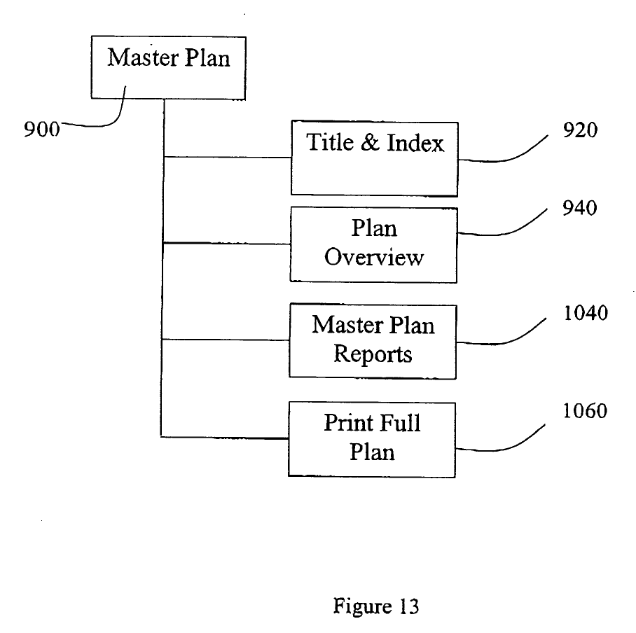

Referring to FIG. 13, the Master Plan module 900 provides the capability to customise and generate a business action plan for the organisation. The Master Plan module 900 comprises a Title & Index sub-module 920; a Plan Overview sub-module 940; a Master Plan Reports sub-module 1040; and a Print Full Plan sub-module 1060.

The Title & Index sub-module 920 enables the title page and the index (or contents) page of the business action plan to be structured by the user. Invocation of report functionality displays the index (or contents) page for the business action plan.

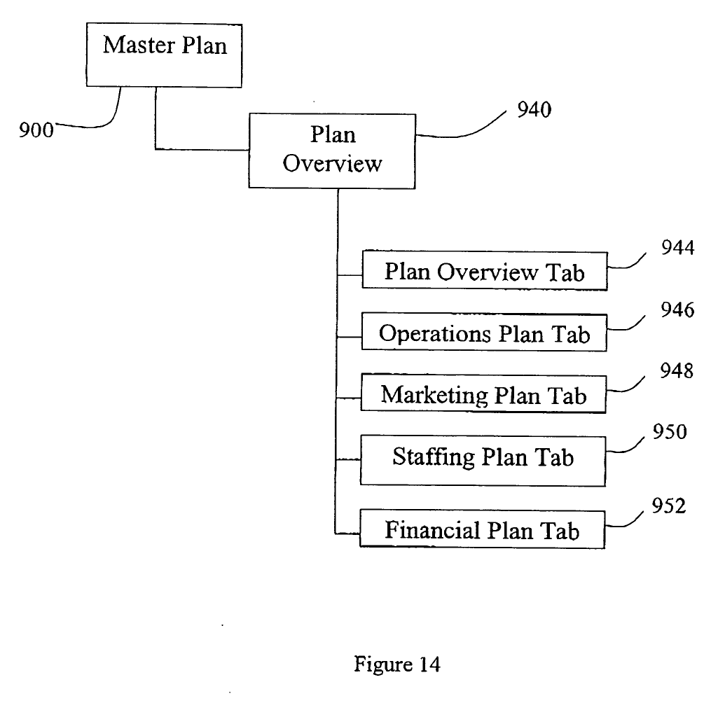

FIG. 14 shows the Plan Overview sub-module 940. The Plan Overview sub-module 940 includes five screen areas in a tabbed arrangement—a Plan Overview tab 944; an Operations Plan tab 946; a Marketing Plan tab 948; a Staffing Plan tab 950; and a Financial Plan tab 952.

The Plan Overview tab 944 enables display and store of information relating to the overall current position of the organisation, including information on the background of the organisation; a situational analysis in brief; the goals for the next year; and an “Our strategies in brief” section.

The Operations Plan tab 946, the Marketing Plan tab 948, the Staffing Plan tab 950 and the Financial Plan tab 952 enable the same kinds of information as described above in relation to the Plan Overview tab 944 to be displayed and maintained for a respective tab. For example, the Marketing Plan tab 948 enables display and store of marketing-related information. The Staffing Plan tab 950 enables display and store of information relating to the costs for each staff member allocated to the project.

Referring to FIG. 13, the Master Plan Reports sub-module 1040 displays a list of the available master plan reports. Invocation of report functionality displays the particular section of the master plan. For example, from the Master Plan Reports sub-module 1040, the financial plan may be selected and displayed. The Print Full Plan sub-module 1060 may be invoked from the Master Plan module 900. The Print Full Plan sub-module 1060 enables an entire business action plan to be printed.

System Module

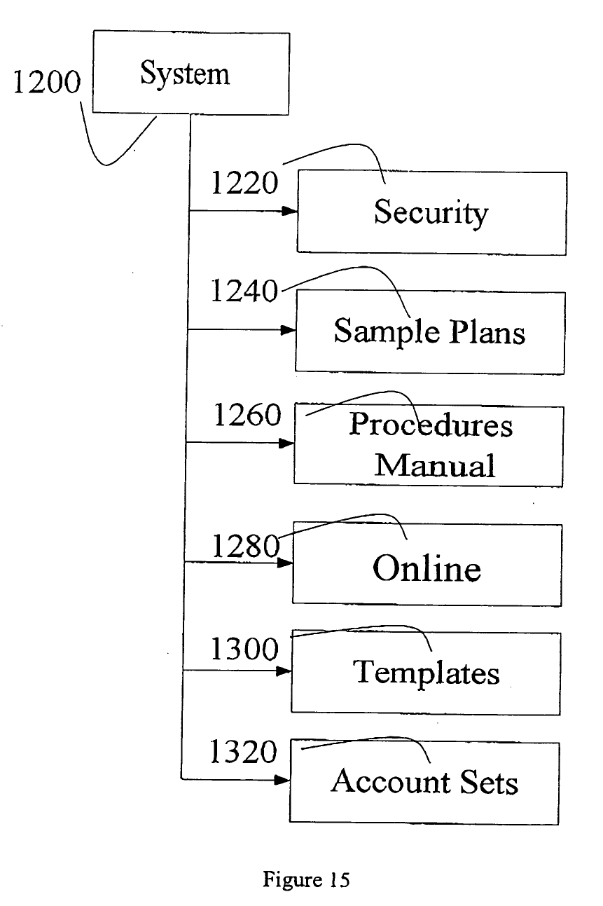

Referring to FIG. 15, the System module 1200 enables security and system parameters for the computer program to be maintained. The System module 1200 comprises a Security sub-module 1220; a Sample Plans sub-module 1240; a Procedures Manual sub-module 1260; an Online sub-module 1280; a Templates sub-module 1300; and an Account Sets sub-module 1320.

The Security sub-module 1220 enables details relating to users of the computer program to be created, deleted and modified. User details such as the username, the password and the security profile for the user may be entered, deleted or modified.

The Sample Plans sub-module 1240 displays a list of sample plans. The Procedures Manual sub-module 1260 is a computer program enabling a user to create procedures manuals. The Online sub-module 1280 starts an HTML browser on the host system and directs the user to an online website. The Templates sub-module 1300 enables a user to print out various templates that may be used during the planning process. The Account Sets sub-module 1320 provides a master Chart of Accounts list for a range of different organisational types.

### EXAMPLE

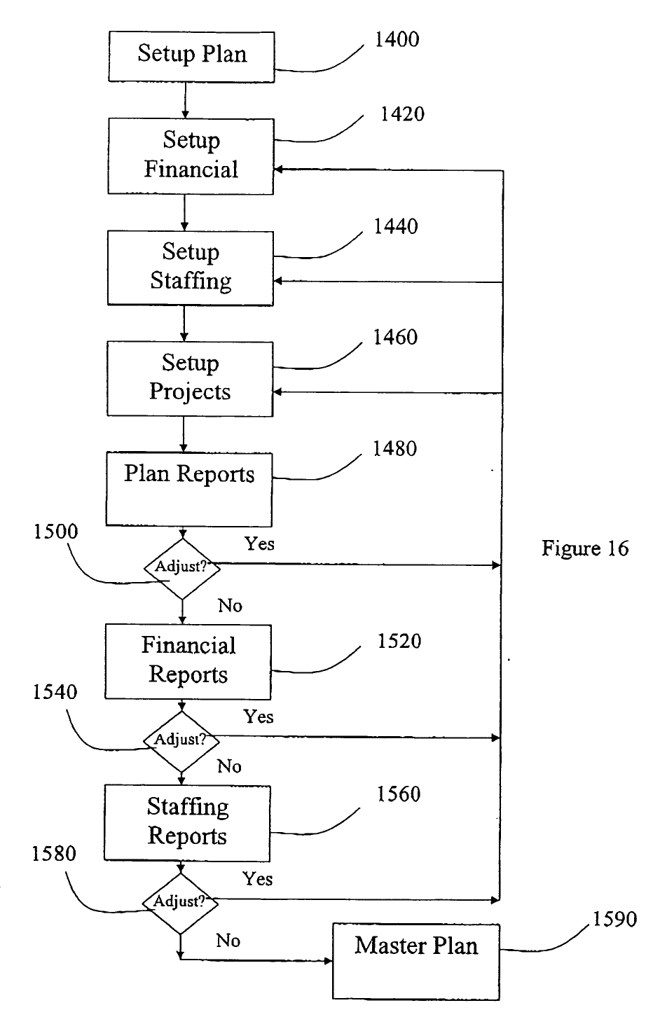

FIG. 16 is a flowchart of the typical steps taken by a user when running the computer program for measuring the impact of a proposed change in an organisation. An example of a fictitious organisation “Joanna's Toys & Books” is employed to illustrate the typical steps taken by a user when running the computer program.

Set-Up Plan

Referring to FIG. 16, at step 1400, a user starts the computer program and begins setting up a plan. Referring to FIG. 5, the user typically navigates to the Company Options sub-module 320 and enters the Company Name (for example “Joanna's Toys & Books”). A start date, an end date and a plan period duration are entered. As an example, the plan may be set to run from a start date of 1 Jul. 2005 to an end date of 30 Jun. 2006 and a plan period of 12 months duration.

Next, the user enters a last review date and then selects whether to run a single plan or a multiple (multi) plan. Multi-plan may be selected if the user, for example, requires separate financial budgets for each division of the organisation. The user selects whether account numbers should be shown on reports and enters a start position and character length for the Account numbers. The user may add, delete or modify divisions of “Joanna's Toys & Books” to reflect the physical structure of the organisation. When satisfied that the data is correct, the user may save the data.

Referring to FIG. 5, the user typically navigates to the Special Events sub-module 340. The user may create, duplicate and delete special events as required. A Special Event record requires entry of the Special Event date, a description of the Special Event; and selection of a Special Event colour. For the “Joanna's Toys & Books” organisation, a user may create Special Events such as “Christmas” and “New Year” holidays; “Pre-Christmas Sales Week”; and “National Reading Day”, for example. A report may be invoked which displays information on the special events for the organisation. When satisfied that all special event data has been entered and is correct, the user may save the data.

Setup Financial

Referring to FIG. 16, at step 1420, the user typically sets up the financials for the plan. Referring to FIG. 5, the user navigates to the Profit/Loss Statement sub-module 360 to input accounts data. Account records may be manually created, amended or deleted by the user as required. Alternatively, Profit and Loss data may be imported from a data file. As another alternative, the user may select an Account Chart from a list of account chart types and generate the account codes and manually enter relevant dollar amounts. Once the Profit and Loss Account information is input, a new budget may then be generated. A report displaying a Profit and Loss statement for the plan period may be invoked by the user.

The user then navigates to the Budget sub-module 400 where the new budget, as generated in the Profit/Loss Statement sub-module 360, may be manually adjusted by the user. Adjustments may be made for any known seasonal or other trends likely to occur in the plan period. The budget may also be amended directly for any other reason. Monthly budget figures (such as interest payments, motor vehicle expenses, and wages) may be adjusted for any month in the plan period. Budget entries may be created and deleted by the user as required. The budget, once amended, reflects the financial status of the organisation, before any projects are initiated. Once the user is satisfied with the budget, the user saves the data. The budget will be automatically updated in response to any changes that are later made to the data relating to the proposed projects. A “pre-project” budget report for any division of the organisation or as a consolidated budget report for the entire organisation may be generated.

Setup Staffing

Referring to FIG. 16, at step 1440, the user then typically sets up the human resource information for the organisation. The user may impose a maximum threshold for productivity across the organisation (for example 95%). This threshold indicates the optimum productivity level for the organization. Any further increase in productivity may well incur a cost to the organisation in terms of additional labour and/or overtime for staff members.

Referring to FIG. 5, the user navigates to the Staffing sub-module 420 in which staff members of the organisation may be maintained. Staff member records may be created, amended or deleted by the user. Data such as a staff member's name; their position, the hours worked per week; their individual productivity estimation; their cost; and their leave information may be entered.

For example, for “Joanna's Toys & Books”, the user may wish to set up a new staff member named “Joanna Q Betts”. The user navigates to the Staffing sub-module 420 and typically enters an Employee ID of “JB”; the name “Joanna Q Betts”; the position of “Manager”; the hours per week of “50”; the estimated productivity for Joanna Betts of “90%”; the cost of “58,000”; and annual leave dates The user may then save the data.

A report may be invoked by the user which displays staff member information for the organisation. Once satisfied with the human resource information, a staff availability budget may be generated.

Once a staff availability budget is generated, the user then navigates to the Staffing Availability sub-module 440 which provides for staff budgeting on both an “hours available” basis and an “estimated productivity” basis. The user may adjust the availability of each staff member for each month during the plan period. The staffing availability budget may then be amended for any known seasonal or other trends likely to occur in the plan period. The staffing availability budget may also be amended directly for any other reason. For example, the availability hours for “Joanna Betts” may be set to zero in the months of December 2005 and January 2006, indicating an anticipated holiday period. Once monthly availability has been adjusted, the user saves the data. Two reports may be invoked by the user. These are an hour availability report and a productivity report. These reports are typically produced prior to the addition of projects for the organisation.

Set-Up Projects

Referring to FIG. 16, at step 1460, the user then typically sets up the proposed projects for the organisation. Referring to FIG. 5, the user navigates to the Projects sub-module 460 where projects for the organisation may be maintained. Projects may be created, amended or deleted by the user.

Referring to FIG. 6, creating a new project requires the user to input several sets of information on seven tabbed areas of the Projects sub-module 460. The first is the Details tab 462 which requires the user to enter a project ID; a short description; the person responsible for the project; a start date; a completion date; the project colour; and a long description for the project. For example, a new project “Systems Manual” may be created for “Joanna's Toys & Books”. The project ID is entered by the user as “Systems Manual”. A short description; the person responsible for the project; the project start and end dates; and a long description or rationale for the project are also entered.

If the start date of a project is changed, the timing of the financial cash flow and human resource labour requirements are automatically updated. If the project is deemed not to be required after review, the project may be deleted and the financial and human resource forecasts will be automatically updated accordingly.

The next tab is the Financial Costs tab 464 which requires the user to enter details of costs associated with each component of the project The user enters the financial cost description; the budget cost; the actual cost; the “from” date; the “to” date; and the account number. For the “Systems Manual” example project, costs may be entered in relation to particular components of the project such as “Manual software application” and “Office Stationery for Manual”.

The next tab is the Project Income tab 466 which requires the user to enter details of income, if any, associated with each component of the project. The user will enter the financial income description; the budget income; the actual income; the “from” date; the “to” date; and the account number. For the “Systems Manual” example project, no expected income is entered.

The next tab is the Staffing Costs tab 468. The user may assign staff members to components of the project. Details include a description of the component; the total hours; the “from” date; the “to” date; and the staff member assigned to the component of the project. For the “Systems Manual” example, the user may enter details of staff members associated with particular components of the “Systems Manual” project. For example, “Joanna Betts” may be assigned as a staff member to the “Research application software” project component. Thus, the user has recorded in the computer program that “Joanna Betts” will be incurring time on the “Research application software” component of the “Systems Manual” project.

The Project Targets tab 470 enables a user to enter details of specific targets for the project. The user enters a description; the due date; the estimated percentage of the project completed at the target due date; the date the target was completed; and the estimated percentage of completion of the project. For example, a typical project target for the “Systems Manual” project might be to “Learn to use software” by 26 Aug. 2005, at which time it is estimated that 30% of the project would be complete.

The next tab is the Review tab 472. The user enters details of review dates and any commentary for the particular reviews. The last tab is the Achievements Comments tab 474, where the user may enter details of the achievements to date in regard to the project.

The user may invoke generation of a project report which details the rationale behind the project; the operational dates; financial income and costs information for the project; the staff members associated with the project; and the time spent by staff members on the project: When satisfied with the projects data, the user may save the data.

Plan Reports

Referring to FIG. 16 at step 1480, the user then typically runs the plan reports for the plan period. Referring to FIG. 8, the user navigates to the Strategy Plan Chart sub-module 610, which graphically displays projects; special events; and human resource and financial surpluses (or deficits) on a monthly timeline. The projects and special events are colour coded to assist the user with identification. The user may click on a horizontal timeline bar for any project or select an Amend function to review the details of the project as described in Step 1460. The user may invoke a report that displays a graphical timeline of the projects; special events; human resources data; and financial surpluses (or deficits) data. The user may then navigate to the Project Chart sub-module 620 and invoke generation of a report that displays a graphical timeline of the project and special events for either a full plan period or on a month-by-month basis.

Referring to FIG. 16, at step 1500, the user determines whether the proposed projects in the plan period are satisfactory, for example, in terms of feasibility and an efficient use of the organisation's resources. If the user determines that the proposed projects data should be adjusted (Yes), the user may return to any of steps 1420, 1440 or 1460 to adjust financial, staffing or projects data, respectively. If the user determines that no adjustment is necessary to the proposed projects data (No), the user moves forward to step 1520. Thus, the user may continuously and iteratively review the proposed projects and the impact that these proposed projects may have on the organisation. The user may decide whether the projects are feasible, infeasible or should be completed at another time.

In terms of change management, the computer program provides the user with a quick and effective means of determining the feasibility of a proposed project or projects.

Financial Reports

Referring to FIG. 16, at step 1520, the user then typically reviews the financial reports for the plan. Referring to FIG. 8, the user first navigates to the Budget with Projects sub-module 700 and selects either one division or all the divisions of “Joanna's Toys & Books” on which to report. Referring to FIG. 9, the Budget with Projects sub-module 700 generates a budget report 702 for the organisation for the plan period. The user then reviews the budget report 702 to determine the suitability of costs. For example, the user may review how the “Systems Manual” project impacts on the monthly financial budget figures for the plan period. The user typically reviews the affordability and timing of the project.

Referring to FIG. 8, the user may then navigate to the Forecast Profit sub-module 720. Referring to FIG. 10, the Forecast Profit sub-module produces a forecast profit and loss statement 722 for the plan period.

Referring to FIG. 8, the user may then navigate to the Budget with Profit sub-module 740. Referring to FIG. 11, the Budget with Profit sub-module 740 displays a Budget with Profit report 742 which provides an accountant's interpretation of the budget for the plan period incorporating the changes imposed by the projects of the organisation. Rather than showing costs associated with individual projects, the costs associated with the projects are allocated directly to the expenses and capital of the organisation for the plan period to provide forecast profitability information for the organization.

Referring to FIG. 8, the user may then navigate to the Graphical Analysis sub-module 760, which displays a graphical view of forecast cumulative sales and profitability in months. Pie charts display the costs of goods versus income and overheads.

Referring to FIG. 16, at step 1540, the user then determines whether the entered financials data for the plan period is satisfactory. If the user determines that the financials data should be adjusted (Yes), the user may return to any of steps 1420, 1440 or 1460 to adjust the financial, staffing or projects data respectively. If the user determines that the financials data does not require adjustment (No), the user moves forward to step 1560.

Staffing Reports

Referring to FIG. 16, at step 1560, the user then typically reviews the staffing reports for the plan. Referring to FIG. 8, the user navigates to the Availability Chart sub-module 780 which displays a graphical view of the availability for the staff members of the organisation. The graphical availability chart may be viewed on a month-by-month or day-by-day basis. The user may easily identify which staff members are under-utilised (surplus capacity); over-utilised (negative deficit capacity for which the organisation will have to consider whether additional labour costs are warranted to assist the staff member complete the tasks in ordinary time); and at full capacity (no ability to accept further responsibilities without accepting further costs).

The user may run a Checklist report which displays the responsibilities for an individual staff member. The user may also nm a report which graphically displays the availability of all staff members for the organisation during the plan period. For example, the user may run the Availability Report to assess whether “Joanna Betts” is under-utilised, over-utilised or has normal productivity levels during the plan period.

Referring to FIG. 8, the user may then navigate to the Human Resource Cost sub-module 800, which produces a productivity schedule (or capacity report) 802 for the plan period. Referring to FIG. 12, the productivity schedule 802 lists the staff members and the projects for the organisation and provides a “work hours” capacity (surplus or deficit) for each month of the plan period. For example, the user may run the productivity schedule to assess what impact a proposed project, such as “Systems Manual”, may have on the overall work capacity of “Joanna's Toys & Books”.

Referring to FIG. 16, at step 1580, the user then determines whether the entered staffing data for the plan period is satisfactory. If the user determines that the staffing data should be adjusted (Yes), the user may return to any of steps 1420, 1440 or 1460 to adjust financial, staffing or projects data, respectively. If the user determines that no adjustment is necessary (No), the user optionally moves forward to step 1590.

Master Plan

Referring to FIG. 16, at step 1590, the user may customise the business action plan to specific requirements and print a formalised business plan suitable for presentation purposes. This plan is referred to as a Master Plan. Alternatively, a short form of the business action plan may be compiled. Referring to FIG. 8, the short business action plan typically includes output from the Project Chart sub-module 620; Financial Budget with Projects sub-module 700, and Staffing Budget HR Cost sub-module 800.

Referring to FIG. 13, the user navigates to the Master Plan module 900 to customise the contents of the formalised business action plan. The user will typically navigate to the Title and Index sub-module 920, where the user may modify the business action plan title and the arrangement of the sections and reports of the business action plan.

The Title and Index sub-module 920 displays one or more index entries (or components) of the business action plan in a grid format. Each index entry represents a specific content area of the business action plan the user may wish to include in the plan. For example, if the user wishes to include an operations section and a marketing section in the business action plan, then an index entry for each of the operations section and the marketing section must be added. Index entries may be added, deleted and modified as required.

To begin customizing the contents of the business action plan, the user clicks on the first index entry in the grid. The user selects whether this index entry is to be a section type or a report type. Selecting a section type will enable the user to enter text describing the section and indicates that the section is to be included on the index page of the business action plan. Selecting a report type indicates that a particular report is to be included in the business action plan. For example, the user may wish to include the Forecast Profitability report and the Budget report in the Finance section of the business action plan. To achieve this, the user adds a Finance section type index to the grid. The user then adds two report type indexes to the grid, corresponding to the Forecast Profitability report and the Budget report. The user may then save the data. The user may invoke generation of a report displaying the index (contents) page of the business action plan showing the sections and reports of the business action plan.

Tables 1 to 22, hereinafter, show an example of a formalised business action plan (Master Plan) for the fictitious organisation “Joanna's Toys & Books”, generated in accordance with an embodiment of the present invention.

Table 1, hereinafter, shows the Title Page of the business action plan when printed.

Table 2, hereinafter, shows the Index Page. The index page includes, at the top, the name of the company “Joanna's Toys & Books”, followed by the name of the plan and the start and end dates for the plan. The index page contains the sections and reports of the plan as customised by the user in the Title and Index sub-module 920. As shown in Table 2, the index page includes a Plan Overview section including three reports; an Operations Plan section including four reports; a Marketing Plan section including two reports; a Staffing Plan section including four reports; and a Finance Plan section including five reports.

Table 3, hereinafter, shows an example of a typical Plan Overview page. The Plan Overview page may include information relating to the background of the organisation; a situation analysis in brief; goals for the next year; and our strategies in brief.

Tables 4 and 5, hereinafter, show examples of printed reports that may typically be attached to the Plan Overview section. Table 4 shows a Strategy Plan Chart and Table 5 shows a Project Targets report.

Table 6, hereinafter, shows an example of a typical Operations Plan page. The Operations Plan page may include information relating to the situation analysis in brief; goals for the next year; and our strategies in brief.

Tables 7 to 11, hereinafter, show examples of reports that may typically be attached to the Operations Plan section. Table 7 shows a Project Chart; Table 8 shows a Projects List; and Tables 9 to 11 show Project Reports for three separate projects.

Table 12, hereinafter, shows an example of a Marketing Plan page. The Marketing Plan page includes information relating to the situation analysis in brief; goals for the next year, and our strategies in brief.

Table 13, hereinafter, shows an example of a Staffing Plan page. The Staffing Plan page includes information relating to the situation analysis in brief; goals for the next year; and our strategies in brief.

Tables 14 to 17, hereinafter, show examples of printed reports that may typically be attached to the Staffing Plan sections Table 14 shows the Availability Chart showing colour-coded staff member availability throughout the year; Table 15 shows the staffing budget including the estimated staffing productivity capacity. Tables 16 and 17 show responsibility checklists for two staff members of the organisation, respectively.

Table 18, hereinafter, shows an example of a Financial Plan page. The Financial Plan page includes information relating to the situation analysis in brief; goals for the next year; and our strategies in brief

Tables 19 to 22, hereinafter, show examples of reports that may typically be attached to the Financial Plan section. Table 19 shows a Forecast Profit and Loss Statement; Table 20 shows a Financial Graphical Analysis; Table 21 shows a Financial Budget with Projects; and Table 22 shows a Financial Budget Profit Analysis incorporating Projects.

The generated business action plan is a formalised and structured version (Master Plan) suitable for presentation to third parties. As an alternative, a short form business action plan may be produced which would typically include a Project Chart (referring to Table 7); a staffing Availability Chart Report (referring to Table 14); and a Financial Budget Profit Analysis Report (referring to Table 22).

Generally, the analyses of the impact of the proposed projects in the organisation may be completed in a short timeframe, for example a single day. The business action plan (whether in the formalised or the short form) may be generated on an ad-hoc basis or regularly (e.g. on a monthly or a weekly basis), as may be required by the Organisation. The process may occur as often as is required.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

Computer System for Measuring the Impact of a Proposed Change in an Organisation

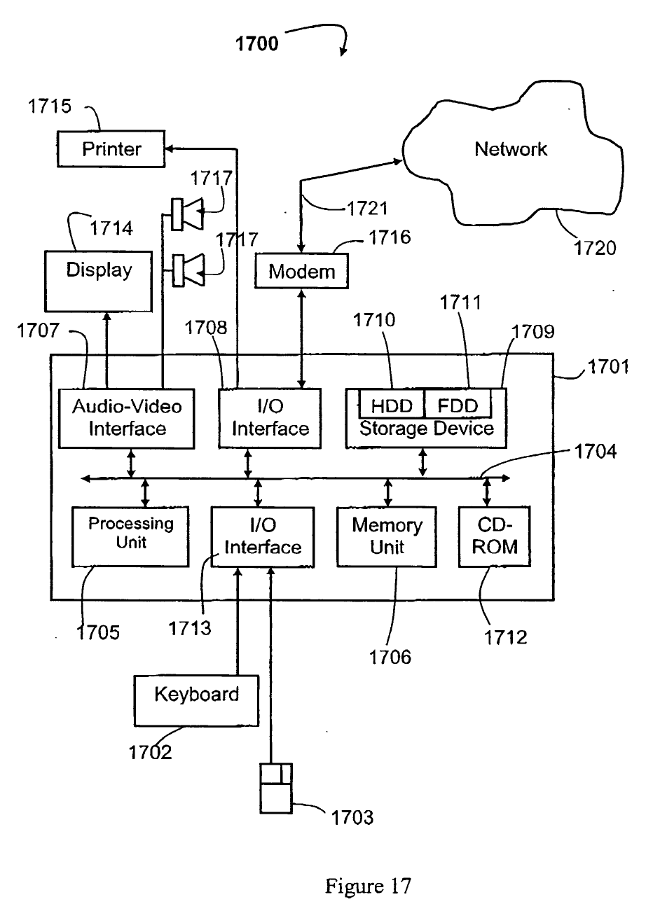

FIG. 17 is a schematic representation of a computer system 1700 that may be used to practise the methods described herein. Specifically, the computer system 1700 is provided for executing computer software that is programmed to assist in performing a computer-based method for measuring the impact of a proposed change in an organisation. The computer software executes under an operating system such as MS Windows XP™ or Linux™ installed on the computer system 1700.

The computer software involves a set of programmed logic instructions that may be executed by the computer system 1700 for instructing the computer system 1700 to perform predetermined functions specified by those instructions. The computer software may be expressed or recorded in any language, code or notation that comprises a set of instructions intended to cause a compatible information processing system to perform particular functions, either directly or after conversion to another language, code or notation.

The computer software program comprises statements in a computer language. The computer program nay be processed using a compiler into a binary format suitable for execution by the operating system. The computer program is programmed in a manner that involves various software components, or code means, that perform particular steps of the methods described hereinbefore.

The computer system 1700 is formed by a computer module 1701, input devices such as a keyboard 1702 and mouse 1703, output devices including a printer 1715, a display device 1714 and loudspeakers 1717. A Modulator-Demodulator (Modem) transceiver device 1716 is used by the computer module 1701 for bi-directionally communicating with a communications network 1720, for example connectable via a telephone line 1721 or other medium such as a wireless interface. The modem 1716 can be used to access the Internet, and other network systems, such as a Local Area Network (LAN) or a Wide Area Network (WAN), and may be incorporated into the computer module 1701 in some implementations.

The, computer module 1701 typically includes at least one processing unit 1705, and a memory unit 1706, for example formed from semiconductor random access memory (RAM) and read only memory (ROM). The computer module 1701 also includes an number of input/output (I/O) interfaces including an audio-video interface 1707 for interfacing to video display 1714 and loudspeakers 1717, an Input/Output (I/O) interface 1713 for interfacing to the keyboard 1702 and the mouse 1703 and optionally a joystick (not illustrated), and au I/O interface 1708 for interfacing to the modem 1716 and printer 1715.

In some implementations, the modem 1716 may be incorporated within the computer module 1701, for example within the interface 1708. A storage device 1709 typically includes a hard disk drive 1710 and a floppy disk drive 1711. A magnetic tape drive (not illustrated) may also be used. A CD-ROM drive 1712 is provided as a non-volatile source of data.

The components 1705 to 1713 of the computer module 1701, typically communicate via an interconnected bus 1704 and in a manner which results in a conventional mode of operation of the computer system 1700 known to those in the relevant art. Examples of specific computers with which the computer software described herein can be executed include IBM-PC's and compatibles, Sun Sparcstations or similar computer systems.

Typically, the computer program is resident on the hard disk drive 1710 and read and controlled in its execution by the processor 1705. Intermediate storage of the program and any data fetched from the network 1720 may be accomplished using the semiconductor memory unit 1706, possibly in concert with the hard disk drive 1710.

In some instances, the computer program may be supplied to the user encoded on a CD-ROM or floppy disk and retrieved via the corresponding drive 1712 or 1711. Alternatively, the computer program may be retrieved from the network 1720 via the modem device 1716. Still further, the computer software can also be loaded into the computer system 1700 from other computer readable media. The term “computer readable medium” as used herein refers to any storage or transmission medium that stores and/or provides instructions and/or data to the computer system 1700 for execution and/or processing. Examples of storage media include floppy disks, magnetic tape, CD-ROM, a hard disk drive, a ROM or integrated circuit, a magneto-optical disk, or a computer readable card such as a PCMCIA card. Examples of transmission media include radio or infra-red transmission channels that provide connection to other computers or networked devices via the Internet or an Intranet.

The computer system 1700 has been described for illustrative purposes. Accordingly, the foregoing description relates to an example of a computer system suitable for practising the methods and computer programs described hereinbefore. Other configurations or types of computer systems can be equally well used to practise the methods and computer programs described hereinbefore, as would be readily understood by persons skilled in the art.

The computer programs and/or methods described hereinbefore comprise a particular control flow. However, other embodiments may use different control flows without departing from the spirit or scope of the invention. Furthermore one or more of the steps of the methods and/or computer programs described hereinbefore may be performed in parallel rather than sequentially.

The foregoing describes only a small number of embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

I claim:

1. A computer-based method for measuring the impact of a proposed change in an organisation, said method comprising the steps of:
inputting financial data relating to the organisation;
inputting human resource data relating to the organisation;
inputting data relating to a proposed initiative for the organisation; and
generating a business action plan for the organisation based on said financial, human resource and proposed initiative data;
wherein said business action plan comprises a forecast for the organisation as a whole that incorporates said proposed initiative.

2. The method according to claim 1, wherein said step of generating a business action plan comprises a step of generating a financial budget for the organisation.

3. The method according to claim 1, wherein said step of inputting data relating to a proposed initiative for the organisation comprises a step of inputting costs relating to said proposed initiative.

4. The method according to claim 1, wherein said step of inputting human resource data comprises a step of inputting data relating to cost, availability and productivity of said human resources.

5. The method according to claim 1, wherein said business action plan comprises one or more sub-plans selected from the group of sub-plans consisting of:
an operations sub-plan;
a financial sub-plan;
a marketing sub-plan; and
a human resource sub-plan.

6. The method according to claim 1, further comprising the step of amending said data relating to said proposed initiative;
wherein said financial data and said human resource data are automatically updated in response to said amendment of said data relating to said proposed initiative.

7. The method of claim 6, further comprising the step of generating an amended business action plan based upon said amended data relating to said project initiative.

8. A computer program product having a computer readable medium having a computer program recorded therein for measuring the impact of a proposed change in an organisation, said computer program product comprising:
computer program code for inputting financial data relating to the organisation;
computer program code for inputting human resource data relating to the organisation;
computer program code for inputting data relating to a proposed initiative for the organisation; and
computer program code for generating a business action plan for the organisation based on said financial, human resource and proposed initiative data;
wherein said business action plan comprises a forecast for the organisation as a whole that incorporates said proposed initiative.

9. The computer program product according to claim 8, wherein said computer program code for generating a business action plan comprises computer program code for generating a financial budget for the organisation.

10. The computer program product according to claim 8, wherein said computer program code for inputting data relating to a proposed initiative comprises computer program code for inputting costs relating to said proposed initiative.

11. The computer program product according to claim 8, wherein said computer program ode for inputting human resource data comprises computer program code for inputting data elating to cost, availability and productivity of said human resources.

12. The computer program product according to claim 8, wherein said business action plan comprises one or more sub-plans selected from the group of sub-plans consisting of:
an operations sub-plan;
a financial sub-plan;
a marketing sub-plan; and
a human resource sub-plan.

13. The computer program product according to claim 8, further comprising;
computer program code for amending said data relating to said proposed initiative;
wherein said financial data and said human resource data are automatically updated in response to said amendment of said data relating to said proposed initiative.

14. The computer program product according to claim 13, further comprising;
computer program code for generating an amended business action plan based upon said amended data relating to said proposed initiative.

15. A computer system for measuring the impact of a proposed change in an organisation, said computer system comprising:
a memory unit for storing data and instructions to be performed by a processing unit; and
a processing unit coupled to said memory unit, said processing unit programmed to:
obtain financial data relating to the organisation;
obtain human resource data relating to the organisation;
obtain data relating to a proposed initiative for the organisation; and
generate a business action plan for the organisation based on said financial, human resource and proposed initiative data, wherein said business action plan comprises a forecast for the organisation as a whole that incorporates said proposed initiative.

16. The computer system according to claim 15, wherein said processing unit is further programmed to generate a financial budget for the organisation.

17. The computer system according to claim 15, wherein said processing unit is further programmed to obtain costs relating to said proposed initiative.

18. The computer system according to claim 15, wherein said processing unit is further programmed to obtain data relating to cost, availability and productivity of said human resources.

19. The computer system according to claim 15, wherein said business action plan comprises one or more sub-plans selected from the group of sub-plans consisting of:
an operations sub-plan;
a financial sub-plan;
a marketing sub-plan; and
a human resource sub-plan.

20. The computer system according to claim 15, wherein said processing unit is further programmed to amend said data relating to said proposed initiative;
wherein said financial data and said human resource data are automatically updated in response to said amendment of said data relating to said proposed initiative.

21. The computer system according to claim 20, wherein said processing unit is further programmed to generate an amended business action plan based upon said amended data relating to said proposed initiative.
